(19) United States
(12) Patent Application Publication
(10) Pub. No.: US 2006/0294420 A1
(43) Pub. Date: Dec. 28, 2006

(54) Isolating and storing configuration data for disaster recovery

(76) Inventor: Janet L. Schneider, Bellevue, WA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/168,822

(22) Filed: Jun. 28, 2005

(51) Int. Cl. G06F 11/00

(52) U.S. Cl. 714/15

(57) ABSTRACT

Methods for performing a backup and/or restore operation of data from a computer. To perform a restore operation, a backup storage device and a configuration storage device are communicatively coupled to a computer. One or more configuration data components are read from the configuration storage device to the computer to guide the restoration of the configuration of the computer. One or more data files are read from the backup storage device and saved to the computer. The data files in backup storage device and the configuration data components in the configuration storage device can be saved in a previous backup operation.

### BACKGROUND OF THE INVENTION

1. The Field of the Invention

The present invention relates to systems and methods for backing up and restoring data. More particularly, embodiments of the invention relate to systems and methods for isolating configuration data components that are utilized in restoring lost data on a computer.

2. The Relevant Technology

In this society where many personal and business interactions are data driven, data can become easily lost or corrupted due to events such as system failures, viruses, power outages, etc. Backing up data has become an important feature of computer networks because of this increasing dependence upon computers and networks to perform vital business and personal functions. The ability to easily, accurately and reliably access data is expected by anyone accessing a computer and/or network.

Backup and recovery of data is typically accomplished through the use of software that backs up the data and that recovers the data from the backup copy. As the amount of data continues to increase, backing up and recovering the data becomes more complex. In particular, recovering data often becomes more challenging as the amount of backup data increases.

When a data backup operation is performed, the backup software typically copies large amounts of data to a separate backup storage medium for safekeeping. Upon the occurrence of a system failure or other data corruption, the data on this backup storage medium can be accessed and copied back to the original system or computer.

Following a system failure or an event that corrupts or destroys data, it is necessary to restore the data that has been previously backed up. In order to accurately restore the data to their proper locations, it is typically necessary to access various configuration data components, which are used by the backup software to determine the manner in which the backed up data should be restored. The configuration data components are various pieces of data that can be accessed prior to completing the data recovery operation to guide the data recovery process. Generally, the recovery software accesses the configuration data components prior to restoring the data. Unfortunately, during conventional data backup operations, the components of configuration data are typically intermingled with the vast amounts of other data that has been backed up. Therefore it can be quite time consuming and tedious to isolate these components of the configuration data prior to performing a data recovery operation.

For example, in many systems, data is backed up on a tape, or a series of tapes. In many conventional systems, configuration data components are stored on the tapes, alongside the other backed up data. To isolate the configuration data components on a tape prior to performing a data recovery operation, it has often been necessary to scroll through each of the tapes individually until each component of configuration data was located. This process can be very protracted when a large amount of data exists on multiple storage tapes and when multiple configuration data components are stored on different storage tapes.

### BRIEF DESCRIPTION OF THE DRAWINGS

To further clarify the above and other features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a block diagram of a system for backing up a configuration dataset on a data storage medium.

FIG. 2 illustrates an exemplary method for performing a backup operation using a configuration storage device.

FIG. 3 illustrates an exemplary method for performing a recovery operation using a configuration storage device.

### DETAILED DESCRIPTION OF EXEMPLARY EMBODIMENTS

Embodiments of the present invention relate to systems and methods for backing up and/or recovering data. As used herein, the term “data” may include, but is not limited to, directories and: subdirectories, user data, system data, applications, services, operating systems, operating system state, and the like, including components of these exemplary types of data, that can be stored on one or more storage devices of a client. Backing up or recovering the operating system may include backing up or recovering any of the data herein defined or understood by those of skill in the art. Data may be organized in logical directories that do not necessarily correspond to a particular storage device so that a user can easily locate information. In one example, in Windows® operating system, the main directories are referred to as volumes. Volumes include, for example, the C drive and D drive, which are typical directories of storage that are located on a client, even though the C or D drive itself may comprise a stack of hard disks. It is not necessary for a user to know from which particular disk to obtain information. Thus, directories exist to help a user navigate through the data on the client. Other directories may exist to which the client has access through a network. In addition, directories and subdirectories can be organized into backup groupings that can be selected to perform a backup or restore of the data corresponding to the backup grouping.

The directories and subdirectories can also be organized in terms of “backup groupings,” which are herein defined as a collection of data that is backed up from the client. A backup grouping can therefore include data on an entire directory, data on less than an entire directory, or data distributed on one or more directories. Thus, the term backup grouping is used as an organizational tool for identifying and locating data that may logically belong together.

This invention facilitates data recovery after the occurrence of a disaster. A disaster may include any event in which data is lost or corrupted in a way that requires the data to be recovered, or when an operating system is corrupted or damaged in any way that requires the operating system to be reinstalled. Data may be lost or corrupted in any number of ways, including a system crash, burglary, a virus, human error, or other damage to the system. A disaster may occur on the server, any of the clients, or both. Where a disaster has occurred, it is necessary to perform a data recovery operation. In general, a data recovery operation includes any of several possible procedures for restoring a computer system and its data after the occurrence of a disaster. One example of a data recovery operation is to transfer the data that was stored on the backup storage medium to its original location, or to another storage medium that has replaced the original storage medium.

Because disasters are likely to occur during the lifetime of most systems, it is a common practice to develop a defense mechanism against disasters. One such defense mechanism is to perform a data backup operation on the system. A data backup operation normally includes creating a backup file that is transferred to a backup storage medium, such as a an optical disk, hard disk, floppy disk, tape, or any other storage medium that can be physically stored in a location separate from the server or client being backed up. The purpose is to have available a copy of data that can be restored in case of a disaster. When data is backed up, it is typically necessary to prepare for every possible situation of losing data—including corruption of a storage device containing any of the data described above. Thus, backups generally include a back up of components of configuration data and, optionally, other information that can be accessed during a data recovery operation and used to initiate and guide the data recovery operation.

As briefly described above, isolating and acquiring the components of configuration data is often a precursor to performing a recovery of data. Once the configuration data components have been saved, the configuration data components can later be accessed to facilitate and direct the data recovery operation. However, in many conventional systems, when a data backup operation is performed, the configuration data components are often intermingled or buried amongst a daunting amount of data. Therefore, isolating and acquiring the various configuration data components prior to a data recovery operation is often a difficult and time consuming task. This is particularly true where the data has been backed up on multiple tapes, disks, or other storage devices. During a data recovery operation, to locate and isolate the necessary configuration data components, the user has often been required to review multiple storage devices until the desired configuration data components were found, which can be a time-consuming task.

Attempts have been made to facilitate the procedure of isolating the configuration data components. For example, during a data backup operation, the server may provide the user with some type of notification as to the location of the relevant configuration data components on the storage devices. For example, the server might print out a statement or send an email indicating the storage device(s) and/or location of the component(s) of configuration data. Although this technique assisted the user in narrowing the search for the configuration data components while performing a data recovery operation, this technique still had various limitations. For example during a data recovery operation, the user was still usually required to find the correct disk or tape on which the particular configuration data component(s) was located and then review the disk or tape until the relevant configuration data component(s) was located.

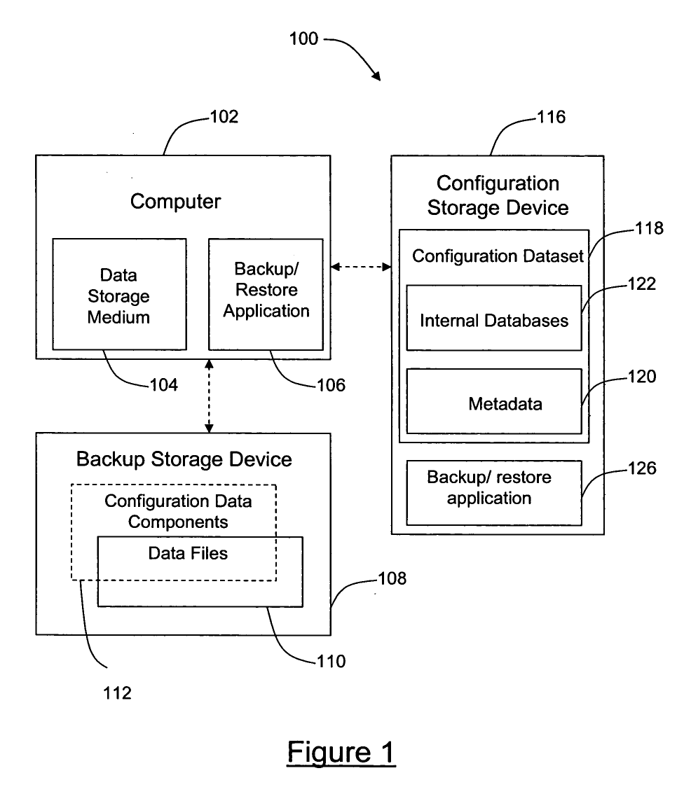

The present invention provides systems and methods for isolating the configuration data components during a data backup operation, for storing the configuration data components during a backup operation in a manner that during a data recovery operation, the configuration data components are easily retrievable. FIG. 1 illustrates an exemplary system 100 for storing configuration data components during a data backup operation which are easily accessible during a data recovery operation. FIG. 1 depicts a computer 102 that is in communication with a backup storage device 108. In one embodiment, computer 102 is an individual computer. In another embodiment, computer 102 is a server that is in communication with a network of client computers. In another embodiment, computer 102 is a client computer that is communicatively coupled to a central server. Computer 102 can be relatively simple (e.g., a desktop computer) or relatively complex (e.g., a large database server or a cluster of servers). Computer 102 may further be a network or a storage area network (SAN).

Computer 102 includes a data storage medium 104 for storing data, such as, but not limited to, directories and subdirectories, user data, system data, applications, services, operating systems, operating system state, and the like, including components of these exemplary types of data. Computer 102 further includes at least one backup and/or restore software application 106 that may be utilized to backup data from data storage medium 104 onto backup storage device 108. When a data recovery operation is performed, software application 106 can be installed and/or executed on computer 102 for restoring data from backup storage device 108 to computer 102.

Backup storage device 108 may be one of many mediums that are commonly employed in the art to store backup data located on computer 102, e.g., an individual computer or a server. Examples include, but are not limited to, disk storage (e.g., optical disks, hard disks, floppy disks, zip disks, and the like), tape storage (e.g., magnetic tape, paper tape), solid state memory devices (e.g., flash memory, EEPROM, and the like), as well as any other storage medium currently known in the art or developed in the future.

System 100 allows a user (e.g., system administrator) to selectively backup data that is stored on computer 102 by invoking backup/restore application 106, whether remotely through a server computer or locally at the computer 102. When backup/restore application 106 is invoked, configuration data components 112 and any other data files (represented by data files 110) selected by the user is stored in backup storage device 108. Various procedures may be implemented to transfer configuration data components 112 and data files 110 to backup storage device 108, including the procedures disclosed herein. By way of example, one procedure by which the configuration data components 112 and data files 110 may be copied to backup storage device 108 can be found in co-pending U.S. patent application Ser. No. ______, filed ______, and entitled “Creation of a Single Client Snapshot Using a Client Utility,” which application is hereby incorporated by reference in its entirety.

As used herein, the term “configuration data” refers to data that is generated and saved during backup operation by a backup/restore application 106 and subsequently used by a recovery application (which can be the same or different application as backup/restore application 106) to restore data files 110 back to a recovery computer. However, the configuration data is not itself restored back to a recovery computer. In one embodiment, one or more components of configuration data can be one or more internal databases. In general, the internal databases contain information regarding the configuration of the computer 102 at the time a data backup operation is performed. The internal databases contain data that is needed by the backup server or backup application to perform a data backup or restore operation. In the case where computer 102 is a server, the internal databases may include, but are not limited to, indexes of all devices that are coupled to the server, indexes of all clients coupled to the server, indexes of all directories, and the like. In addition, the internal databases may include resource databases which contain configuration information, a schedule for the backups that are to be initiated during a data backup operation, and the like. Another example of one or more components of configuration data is metadata. Metadata is generated and collected during a data backup operation. The metadata may be stored in a format that the operating system of computer 102 will expect when a data recovery operation is performed. In one embodiment, metadata may also allow the computer 102 to reconfigure its partitions correctly.

FIG. 1 depicts backup storage device 108 where the box representing configuration data components 112 overlaps the box representing data files 110 to illustrate that in a conventional backup operation, configuration data components 112 are saved intermingled with data files 110. FIG. 1 also illustrates the box representing configuration data components 112 having a dashed line because in the present invention, in one embodiment, configuration data components 112 may not be saved to backup storage device 110. Thus, the term “data” encompasses both configuration data and data files that can be saved to backup storage device 108. The term “data files” thus represents any other data except for configuration data that can be stored to backup storage device 108.

When a disaster occurs, it is usually necessary to recover the data files 110 from backup storage device 108 to the computer 102 on which the data was originally stored. Alternatively, the data files 110 from backup storage device 108 may be reinstalled on a replacement computer. As described above, when a restore operation is performed, it is often necessary for computer 102 to access configuration data components 112 that guide the restoration process. However, in the case where configuration data components 112 is copied to backup storage device 108 along with the data files 110, because the configuration data components 112 are intermingled with the data files 110, the configuration data components are often difficult and time consuming to isolate. Further, backup storage device 108 can represent multiple storage devices, which can complicate matters when trying to locate the configuration data components 112.

To overcome this difficulty, the present invention gathers and isolates one or more components of configuration data, such as, but not limited to, one or more internal databases 122 and metadata 120, into a configuration dataset 118. This configuration dataset is created during a data backup operation, and is stored in a separate location than backup storage device 108. As shown in FIG. 1, the present invention provides for a configuration storage device 116 which is configured to be communicatively coupled to computer 102 during a data backup operation (shown by dashed line 124). As used herein, the term “communicatively coupled” refers to any means for allowing data to be written to configuration storage device 116. Configuration storage device 116 is configured to store the configuration dataset 118, among other information, for easy access by computer 102 during a data recovery operation. Configuration storage device 116 may be one of many non-volatile storage devices. In one embodiment, the configuration storage device 116 can be a Universal Serial Bus drive such as, but not limited to, a memory stick, thumb drive, and the like. In addition, configuration storage device 116 can be the same storage medium as backup storage device 108 including, but not limited to, disk storage (e.g., optical disks, hard disks, floppy disks, zip disks, and the like), tape storage (e.g., magnetic tape, paper tape), solid state memory devices (e.g., flash memory, EEPROM, and the like), as well as any other storage medium currently known in the art or developed in the future.

In one embodiment, configuration storage device 116 is removable, meaning that it is selectively communicatively coupled to computer 102. In this embodiment, a storage device is received into a port on computer 102 configured to receive configuration storage device 116. Once the backup operation is complete, the user can remove storage device 116 from the port and, hence, from being communicatively coupled to computer 102. In another embodiment, the configuration storage device 116 may communicate with computer 102 externally thereof without having to be physically inserted into a port on computer 102, but still be situated in order to receive data from computer 102. These embodiments include configuration storage device 116 that can communicate with computer 102 via a radio frequency signal, infrared signal, audio signal, optical signal, and the like. Thus, the communicative coupling between configuration storage device 116 and computer 102 may be accomplished by any number of communication links, including wired and wireless links. Note that backup storage device 108 may also be communicatively coupled to computer 102 using any of the same means described herein with regard to configuration storage device 116 or any other means understood by those of skill in the art viewing the disclosure herein.

When a data backup operation is performed, configuration storage device 116 is communicatively coupled to computer 102. Backup/restore application 106 prompts computer 102 to send the components of configuration data to configuration storage device 116 to be saved as a configuration dataset 118. This can include providing a user with a list of potential wired and/or wireless ports to which to send the components of configuration data and allowing a user to select one of the ports. Alternatively, the user can preconfigure the computer 102 to always send the components of configuration data to a particular port for every data backup operation. In one embodiment, one or more backup groupings may be displayed on a graphical user interface to allow a user to select the components of configuration data to be saved. The components of configuration data may be displayed in a backup grouping along with data files 110 to be saved. However, backup/restore application 106 identifies which items of the backup data belong to the configuration dataset 118 and directs the save of these components to the port configured to write to the configuration storage device 116. Components of configuration data are thus stored in a configuration dataset 118 in a known location on configuration storage device 116 for easy accessibility during a subsequent data recovery operation.

In one embodiment, if a configuration dataset 118 has already been stored on configuration storage device 116, it will be overwritten with the new dataset. In another embodiment, if a configuration dataset 118 has already been stored on configuration storage device 116, the new configuration dataset will not overwrite the old, but instead will be written alongside the old dataset, and categorized so as to distinguish itself. The configuration dataset(s) may be categorized using various techniques, including categorization by the date and time at which they were written, categorization by the order in which they were written, or in any number of data categorization techniques.

Thus, during a backup operation, backup/restore application 106 copies the components of configuration data to configuration storage device 116 and/or backup storage device 108 (as shown by dashed box 112). In addition, backup/restore application 106 copies the data files 110 to backup storage device 108. As indicated above, any number of backup procedures may be used to copy the selected data from computer 102 to backup storage device 108 and configuration storage device 116. The user can prompt system 100 to repeat this process each time the user desires to create a backup of all or part of the data stored on computer 102. Alternatively, the user may establish a schedule that defines the times at which computer 102 automatically performs a backup. Each time a data backup operation is performed, a new configuration dataset 118 is saved on configuration storage device 116 to reflect the most recent configuration of computer 102.

After the backup operation, configuration storage device 116 may be moved to a location separate from computer 102 (i.e., an offsite location) such that if a disaster were to occur, such as a flood or fire, the data in computer 102 could still be recovered using configuration storage device 116 which would normally have the most recent configuration dataset 118. The user also has the option of rotating multiple data storage devices 116 to retain multiple versions of the configuration dataset, in case one of the data storage devices is damaged in some way.

Thus, as illustrated in FIG. 1, configuration storage device 116 can include a configuration dataset 118 which comprises one or more components of configuration data. By way of example, but not limitation, configuration dataset 118 may include the internal databases 122 and metadata 120. Other types of configuration data may also be included within the configuration dataset 118, depending on the hardware configuration and the operating system being employed. As will be described below, once the configuration dataset 118 is saved to configuration storage device 116, the recovery process using configuration storage device 116 is quite simple and efficient. However, if the configuration data has not been separately stored in accordance with the present invention, the recovery process may potentially be tedious and time-consuming because of the need to search for the components of configuration data. Thus, the present invention provides for an efficient way to isolate and store configuration data for recovery, which can, in most cases, reduce the time required to perform a recovery operation.

In addition to configuration dataset 118, configuration storage device 116 may also include other data that may be used during a data recovery operation. For example, in one embodiment, configuration storage device 116 may include a backup/restore application 126. This application may be useful during a data restore application on a computer that has lost its backup/restore applications 106 during a disaster, due to deletion or corruption of files. Where a disaster has deleted or corrupted backup/restore application 106 from computer 102, it is often necessary that at least a version of the backup/restore application 126 be reinstalled prior to completing the data restore operation. By including backup/restore application 126 on configuration storage device 116, application 126 can be easily be loaded onto computer 102 for utilization during the data restore operation. The backup/restore application 126 can be written to configuration storage device 116 before, during or after a backup operation.

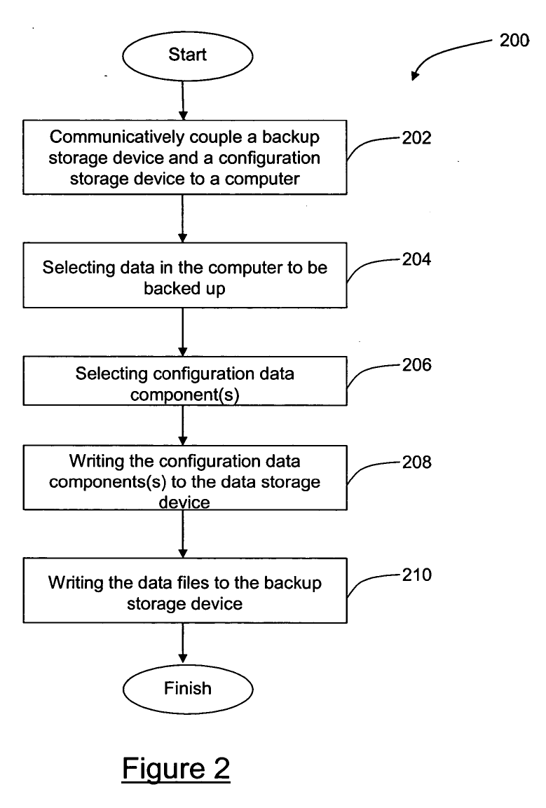

As illustrated in FIG. 2, an exemplary method 200 for performing a data backup operation thus includes, at 202, communicatively coupling a backup storage device 108 and a configuration data storage device 116 to a computer 102. At 204, the user selects data files 110 stored in the computer 102 to be saved during the backup operation. At 206, the user selects one or more configuration data components to be saved to configuration storage device 116 for, use during a subsequent data recovery operation, wherein the backup/restore application 106 compiles the selected configuration data component(s) into a configuration dataset. At 208, computer 102 writes the configuration dataset to the configuration storage device 116. At 210, data files 110 are also written from the computer 102 to backup storage device 108.

Although the elements of method 200 appear in a sequential order in FIG. 2, it is not necessary that all of the elements occur in the sequence shown. For example, elements 202, 204, 206, and 210 may occur simultaneously, or in any order. Also, element 208 may occur simultaneously or in any order with many of the elements, so long as it occurs after selecting 206 the configuration data components on the computer. In addition, as previously indicated, the backup storage device 108 and configuration storage device 116 may be removable, such that they can be stored in a different location than the backed-up computer. Therefore, the above methods may also include the step of removing the data storage device from the computer after the completion of a data backup operation. Thus, it will be appreciated by those of skill in the art that the exemplary process described above is provided by way of illustration and not by way of limitation and that process elements, steps and/or actions can be rearranged in order, combined and/or eliminated and that other actions may be added due to design considerations depending on the operating system platform and/or backup/restore application 106 running on the computer 102.

Following a disaster necessitating a data recovery operation, the user again communicatively couples configuration storage device 116 to computer 102 or to another system to which the data files 110 from computer 102 will be restored. To initiate the recovery operation, the user prompts computer 102 to enter into a data recovery mode. Prior to restoring any data from backup storage device 108, computer 102 accesses components of configuration dataset 118 located on configuration storage device 116. In the embodiment depicted in FIG. 1, computer 102 specifically accesses from configuration dataset 118, internal databases 122 and metadata 120. The internal databases and metadata provide instructions and information to computer 102 as to the pre-disaster configuration of the computer, the indexes of the backed-up data and storage directories, and/or various other details concerning the reconfiguration and restoration of the system. With this information, computer 102 is able to access the data files 110 in backup storage device 108 without difficulty, and restore all of the necessary data and programs in their pre-disaster configurations.

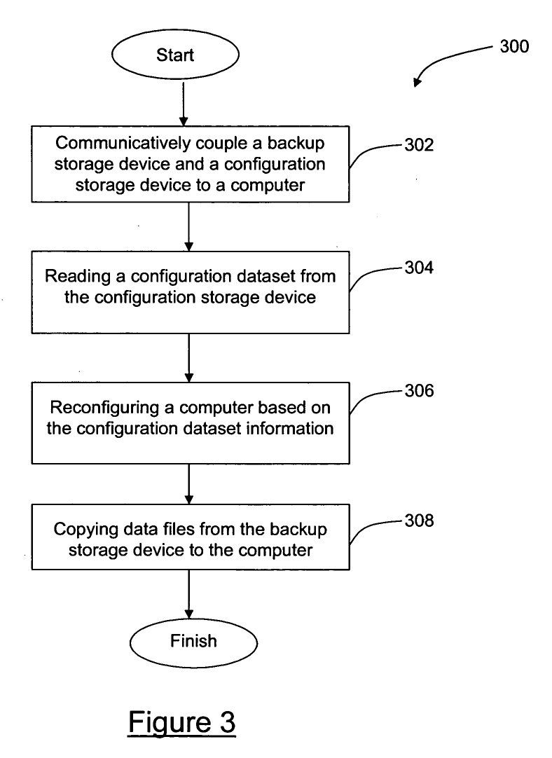

FIG. 3 illustrates an exemplary method 300 for performing a data recovery operation including, at 302, communicatively coupling a backup storage device 108 and a configuration storage device 116 to a computer 102. The configuration storage device 116 includes a configuration dataset that was written to the configuration storage device during a preceding backup operation of a backed-up computer and containing information regarding the configuration of the backed-up computer. At 304, the recovery computer reads at least the configuration dataset from the configuration storage device 116. At 306, the recovery computer is reconfigured using information obtained from at least the configuration dataset. At 308, data files 110 are copied from backup storage device 108 to recovery computer using information from at least the configuration dataset.

Although the elements of method 300 appear in a sequential order in FIG. 3, it is not necessary that all of the elements occur in the sequence shown. For example, elements 306 and 308 may occur simultaneously, or in reverse order. Thus, it will be appreciated by those of skill in the art that the exemplary process described above is provided by way of illustration and not by way of limitation and that process elements, steps and/or actions can be rearranged in order, combined and/or eliminated and that other actions may be added due to design considerations depending on the operating system platform and/or backup/restore application 106 running on the computer 102.

As stated above, computer 102 may be either a server in connection with a network of client computers, a client computer that is communicatively coupled to a central server, or an individual computer. When computer 102 is acting as a server, it can be desirable that configuration dataset 118 is isolated and easily ascertainable during a data restore operation, because it usually will have no other server to contact for direction on the recovery procedure. Therefore, being able to quickly ascertain configuration dataset 118 is particularly beneficial when computer 102 is acting as a server.

The present invention is also beneficial in the embodiments where computer 102 is an individual computer or a client computer in connection with a server. Although a client computer may have the ability of contacting a server following a disaster in order to recover its data, it may also be beneficial for the client to have the ability of efficiently locating its configuration dataset 118 on a configuration storage device 116. Therefore, the present invention also discloses the ability to save a client's configuration dataset on a data storage device for easy accessibility following a disaster. This may especially be desirable in cases where each client operates on a different operating system or platform than the server.

Likewise, the present invention is also beneficial where computer 102 is an individual computer. In the event of a disaster, an individual computer often is unable to contact a server or any other outside source in order to receive direction during a data recovery operation. Therefore, it is also beneficial for the individual computer to store its configuration dataset on a configuration storage device 116 for efficient accessibility following a disaster.

System 100 is not limited to any particular hardware configuration or operating system. Various hardware configurations and operating systems have need of locating the internal databases or other configuration data prior to a data recovery operation. Many of these hardware configurations and operating systems currently require the data on the backup storage device to be scanned in order to isolate the internal databases or other configuration data components. Therefore, these hardware configurations and operating systems would benefit from isolating the configuration data and storing these components as a configuration dataset on a separate storage device during a data backup operation, such that the configuration dataset would be easily accessible during a data recovery operation.

Embodiments included dedicated devices or systems that include both hardware and/or software components. Embodiments within the scope of the present invention also include computer readable media having executable instructions or data fields stored thereon. Such computer readable media can be any available media which can be accessed by a general purpose or special purpose computer. By way of example, and not limitation, such computer readable media can comprise RAM, ROM, EEPROM, CD-ROM or other optical disk storage, magnetic disk storage or other magnetic storage devices, or any other medium which can be used to store the desired executable instructions or data fields and which can be accessed by a general purpose or special purpose computer. Combinations of the above should also be included within the scope of computer readable media. Executable instructions comprise, for example, instructions and data which cause a general purpose computer, special purpose computer, or special purpose processing device to perform a certain function or group of functions.

Although not required, the invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable customer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of performing a data recovery operation on a computer having a data storage medium, the method comprising:
identifying one or more configuration data components saved on a configuration storage device;
using the identified one or more configuration data components to reconfigure the data storage medium of the computer;
identifying one or more data files stored on a backup storage device to be restored to the computer; and
writing the identified one or more data files to the data storage medium on the computer.

2. The method as recited in claim 1, wherein identifying one or more data files and identifying one or more configuration data components is performed automatically by a data recovery application residing on the computer.

3. The method as recited in claim 1, wherein identifying one or more data files and identifying one or more configuration data components comprises receiving a selection from a user through a graphical user interface regarding one or more data files and one or more configuration data components to access during the data recovery operation.

4. The method as recited in claim 1, further comprising accessing a recovery application stored on the configuration storage device.

5. The method as recited in claim 1, wherein the one or more configuration data components comprises at least one of an internal database of the computer or metadata.

6. The method as recited in claim 1, further comprising communicatively coupling the configuration storage device to the computer.

7. The method as recited in claim 6, wherein communicatively coupling a configuration storage device to the computer comprises selectively communicatively coupling at least one of a Universal Serial Bus drive, floppy disk, an optical disk, or a zip disk.

8. The method as recited in claim 6, wherein communicatively coupling a configuration storage device to the computer comprises using at least one of a radio frequency signal, an infrared signal, an audio signal, or an optical signal to establish communication with the first storage device.

9. A computer readable medium having computer executable instructions for performing the method of claim 1.

10. In a computer system that includes a computer having a data storage medium, a method for performing a data recovery operation of the computer system, the method comprising:
communicatively coupling a backup storage device to the computer;
communicatively coupling a configuration storage device to the computer;
executing a backup application that directs the recovery operation;
identifying one or more configuration data components to be accessed from the configuration storage device;
using the identified one or more configuration data components to reconfigure the data storage medium;
identifying one or more data files on the backup storage device to be restored to the data storage medium; and
writing the identified one or more data files from the backup storage device to the data storage medium.

11. The method as recited in claim 10, wherein executing a backup application that directs the recovery operation comprises accessing a backup application stored on the configuration storage device.

12. The method as recited in claim 10, wherein the one or more configuration data components comprises at least one of an internal database of the computer or metadata describing the configuration of the computer.

13. The method as recited in claim 10, wherein communicatively coupling a configuration storage device to the computer comprises selectively communicatively coupling at least one of a Universal Serial Bus drive, floppy disk, an optical disk, or a zip disk.

14. The method as recited in claim 10, wherein communicatively coupling a configuration storage device to the computer comprises using at least one of a radio frequency signal, an infrared signal, an audio signal, or an optical signal to establish communication with the first storage device.

15. The method as recited in claim 10, wherein communicatively coupling a backup storage device to the computer comprises establishing a remote network connection.

16. The method as recited in claim 10, wherein identifying one or more configuration data components, using the identified one or more configuration data components to reconfigure the data storage medium, identifying one or more data file, and writing the identified one or more data files from the backup storage device to the data storage medium occurs automatically after the backup application is executed.
